(19) United States
(12) Patent Application Publication
(10) Pub. No.: US 2016/0071136 A1
(43) Pub. Date: Mar. 10, 2016

(54) METHOD AND SYSTEM FOR INTEGRATING TRAVEL VISA DATA WITH TRANSACTION DATA

(71) Applicant: MasterCard International Incorporated, Purchase, NY (US)

(72) Inventors: Kenneth UNSER, Fairfield, CT (US); Jean-Pierre GERARD, Croton-On-Hudson, NY (US)

(73) Assignee: MASTERCARD INTERNATIONAL INCORPORATED, Purchase, NY (US)

(21) Appl. No.: 14/477,113

(22) Filed: Sep. 4, 2014

(51) Int. Cl. G06Q 30/02

(52) U.S. Cl. CPC G06Q 30/0205

(57) ABSTRACT

A method for linking travel visa data to transaction history includes: storing a plurality of consumer profiles, each profile including data related to one or more consumers including a plurality of consumer characteristics associated with each of the related one or more consumers and a plurality of transaction data entries each corresponding to a payment transaction involving one of the related one or more consumers; receiving a travel visa profile, the profile including travel visa data associated with one or more specific consumers and a plurality of demographic characteristics associated with each of the one or more specific consumers; identifying a consumer profile of the plurality of consumer profiles where at least a predefined number of the included plurality of consumer characteristics correspond to the plurality of demographic characteristics; and associating each identified consumer profiles with the travel visa data included in the received travel visa profile.

### FIELD

The present disclosure relates to the linking of travel visa data to transaction history, specifically the linking of data associated with the locations and dates of a travel visa with consumer transaction history based on a plurality of demographic characteristics and the identification of travelers based on correspondence between transaction history and visa data.

### BACKGROUND

Transaction data, which may include any useful data captured from a payment transaction, may be useful in a variety of situations. Content providers, such as merchants, retailers, third party offer providers, or advertisers may utilize transaction data to identify targeted content, such as offers and advertisements, to distribute to potential consumers. Transaction data may provide valuable insights as to the potential for a specific consumer to redeem an offer or purchase an advertised product, based on their past transactions.

Similarly, travel visa data, which indicate a geographic location that a consumer may be traveling both to and from, when the consumer will be traveling, and may provide additional insights to the consumer, may also be valuable to content providers and other third parties. When this type of data is gathered, such as via consumer consent or as provided by the visa issuing agency, it may provide this valuable information. It may reveal how many consumers are traveling from one location to another, for what purposes the consumers are traveling, how long consumers are traveling for, what cities or areas the consumers are leaving from and traveling to, and more.

However, while such transaction data or travel visa data may be valuable on their own, a combination of the data could provide for even more valuable data points. For example, travel visa data may identify when a consumer will be traveling to a new country, but may not provide any insight as to how the consumer may spend when they arrive. When combined with transaction data, it may be more easily determined what the consumer's purchasing habits and interests are, which may be used by the issuing country to advertise services, tours, attractions, products, and more to the consumer, or to enhance the country's own statistics regarding visitors and the economy, for example.

Thus, there is a need for a technical solution to link transaction data with travel visa data.

### SUMMARY

The present disclosure provides a description of systems and methods for linking travel visa data to transaction history and distributing linked consumer profiles.

A method for linking travel visa data to transaction history includes: storing, in a database, a plurality of consumer profiles, wherein each consumer profile includes data related to one or more consumers including at least a plurality of consumer characteristics associated with each of the related one or more consumers and a plurality of transaction data entries each corresponding to a payment transaction involving at least one of the related one or more consumers; receiving, by a receiving device, a travel visa profile, wherein the travel visa profile includes travel visa data associated with one or more specific consumers and a plurality of demographic characteristics associated with each of the one or more specific consumers; identifying, by a processing device, at least one consumer profile of the plurality of consumer profiles where at least a predefined number of the included plurality of consumer characteristics correspond to the plurality of demographic characteristics; and associating, in the database, each of the identified at least one consumer profile with the travel visa data included in the received travel visa profile.

A method for distributing a linked consumer profile includes: storing, in a database, a plurality of consumer profiles, wherein each consumer profile includes data related to one or more consumers including at least a consumer identifier associated with the one or more related consumers, a plurality of consumer characteristics, and a plurality of transaction data entries, each transaction data entry corresponding to a payment transaction involving at least one of the related one or more consumers; receiving, by a receiving device, a consumer profile request, wherein the consumer profile request includes at least a specific consumer identifier; identifying, in the database, a specific consumer profile where the included consumer identifier corresponds to the specific consumer identifier; transmitting, by a transmitting device, a request for travel visa data, wherein the request for travel visa data includes at least a predefined number of the plurality of consumer characteristics included in the identified specific consumer profile; receiving, by the receiving device, travel visa data; including, in the database, the received travel visa data in the identified specific consumer profile; and transmitting, by the transmitting device, the specific consumer profile including the received travel visa data in response to the received consumer profile request.

A method for linking travel visa data to consumer data includes: storing, in a database, a plurality of consumer profiles, wherein each consumer profile includes data related to one or more consumers including at least a consumer identifier associated with the one or more related consumers, consumer data, and a plurality of transaction data entries, each transaction data entry corresponding to a payment transaction involving at least one of the related one or more consumers and including at least a geographic location and a transaction time and/or date; receiving, by a receiving device, travel visa data, wherein the travel visa data includes data related to a plurality of issued travel visas including at least an issuing country and one or more travel dates for each issued travel visa; identifying, for each issued travel visa, a corresponding consumer profile in the database based on at least the geographic location and transaction time and/or date for one or more transaction data entries in the corresponding consumer profile and the issuing country and one or more travel dates in the respective issued travel visa; and transmitting, by a transmitting device, at least one of the consumer data and the transaction data entries included in the corresponding consumer profile identified for each issued travel visa included in the received travel visa data.

A system for linking travel visa data to transaction history includes a database, a receiving device, and a processing device. The database is configured to store a plurality of consumer profiles, wherein each consumer profile includes data related to one or more consumers including at least a plurality of consumer characteristics associated with each of the related one or more consumers and a plurality of transaction data entries each corresponding to a payment transaction involving at least one of the related one or more consumers. The receiving device is configured to receive a travel visa profile, wherein the travel visa profile includes travel visa data associated with one or more specific consumers and a plurality of demographic characteristics associated with each of the one or more specific consumers. The processing device is configured to: identify at least one consumer profile of the plurality of consumer profiles where at least a predefined number of the included plurality of consumer characteristics correspond to the plurality of demographic characteristics; and associate, in the database, each of the identified at least one consumer profile with the travel visa data included in the received travel visa profile.

A system for distributing a linked consumer profile includes a database, a receiving device, a processing device, and a transmitting device. The database is configured to store a plurality of consumer profiles, wherein each consumer profile includes data related to one or more consumers including at least a consumer identifier associated with the one or more related consumers, a plurality of consumer characteristics, and a plurality of transaction data entries, each transaction data entry corresponding to a payment transaction involving at least one of the related one or more consumers. The receiving device is configured to receive a consumer profile request, wherein the consumer profile request includes at least a specific consumer identifier. The processing device is configured to identify, in the database, a specific consumer profile where the included consumer identifier corresponds to the specific consumer identifier. The transmitting device is configured to transmit a request for travel visa data, wherein the request for travel visa data includes at least a predefined number of the plurality of consumer characteristics included in the identified specific consumer profile. The receiving device is further configured to receive travel visa data. The processing device is further configured to include, in the database, the received travel visa data in the identified specific consumer profile. The transmitting device is further configured to transmit the specific consumer profile including the received travel visa data in response to the received consumer profile request.

A system for linking travel visa data to consumer data includes: a database, a receiving device, a processing device, and a transmitting device. The database is configured to store a plurality of consumer profiles, wherein each consumer profile includes data related to one or more consumers including at least a consumer identifier associated with the one or more related consumers, consumer data, and a plurality of transaction data entries, each transaction data entry corresponding to a payment transaction involving at least one of the related one or more consumers and including at least a geographic location and a transaction time and/or date. The receiving device is configured to receive travel visa data, wherein the travel visa data includes data related to a plurality of issued travel visas including at least an issuing country and one or more travel dates for each issued travel visa. The processing device is configured to identify, for each issued travel visa, a corresponding consumer profile in the database based on at least the geographic location and transaction time and/or date for one or more transaction data entries in the corresponding consumer profile and the issuing country and one or more travel dates in the respective issued travel visa. The transmitting device is configured to transmit at least one of the consumer data and the transaction data entries included in the corresponding consumer profile identified for each issued travel visa included in the received travel visa data.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for linking travel visa data and transaction history in accordance with exemplary embodiments.

FIG. 2 is a block diagram illustrating the processing server of FIG. 1 for the linking of travel visa data and transaction history in accordance with exemplary embodiments.

FIG. 3 is a flow diagram illustrating a method for linking travel visa data with transaction history in a consumer profile in accordance with exemplary embodiments.

FIG. 4 is a flow diagram illustrating a method for populating and distributing a consumer profile including travel visa data and transaction history in accordance with exemplary embodiments.

FIG. 5 is a flow diagram illustrating a method for identifying consumer profiles that correspond to travel visas based on consumer transaction matching in accordance with exemplary embodiments.

FIG. 6 is a diagram illustrating the linking of consumer travel visa data to transaction history in accordance with exemplary embodiments.

FIG. 7 is a flow chart illustrating an exemplary method for linking travel visa data to transaction history in accordance with exemplary embodiments.

FIG. 8 is a flow chart illustrating an exemplary method for distributing a linked consumer profile in accordance with exemplary embodiments.

FIG. 9 is a flow chart illustrating an exemplary method for linking travel visa data to consumer data in accordance with exemplary embodiments.

FIG. 10 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard®, VISA®, Discover®, American Express®, etc.

Personally identifiable information (PII)—PII may include information that may be used, alone or in conjunction with other sources, to uniquely identify a single individual. Information that may be considered personally identifiable may be defined by a third party, such as a governmental agency (e.g., the U.S. Federal Trade Commission, the European Commission, etc.), a non-governmental organization (e.g., the Electronic Frontier Foundation), industry custom, consumers (e.g., through consumer surveys, contracts, etc.), codified laws, regulations, or statutes, etc. The present disclosure provides for methods and systems where the processing server 108 does not require possessing any personally identifiable information. Systems and methods apparent to persons having skill in the art for rendering potentially personally identifiable information anonymous may be used, such as bucketing. Bucketing may include aggregating information that may otherwise be personally identifiable (e.g., age, income, etc.) into a bucket (e.g., grouping) in order to render the information not personally identifiable. For example, a consumer of age 26 with an income of $65,000, which may otherwise be unique in a particular circumstance to that consumer, may be represented by an age bucket for ages 21-30 and an income bucket for incomes $50,000 to $74,999, which may represent a large portion of additional consumers and thus no longer be personally identifiable to that consumer. In other embodiments, encryption may be used. For example, personally identifiable information (e.g., an account number) may be encrypted (e.g., using a one-way encryption) such that the processing server 108 may not possess the PII or be able to decrypt the encrypted PII.

### System for Linking Travel Visa Data to Transaction History

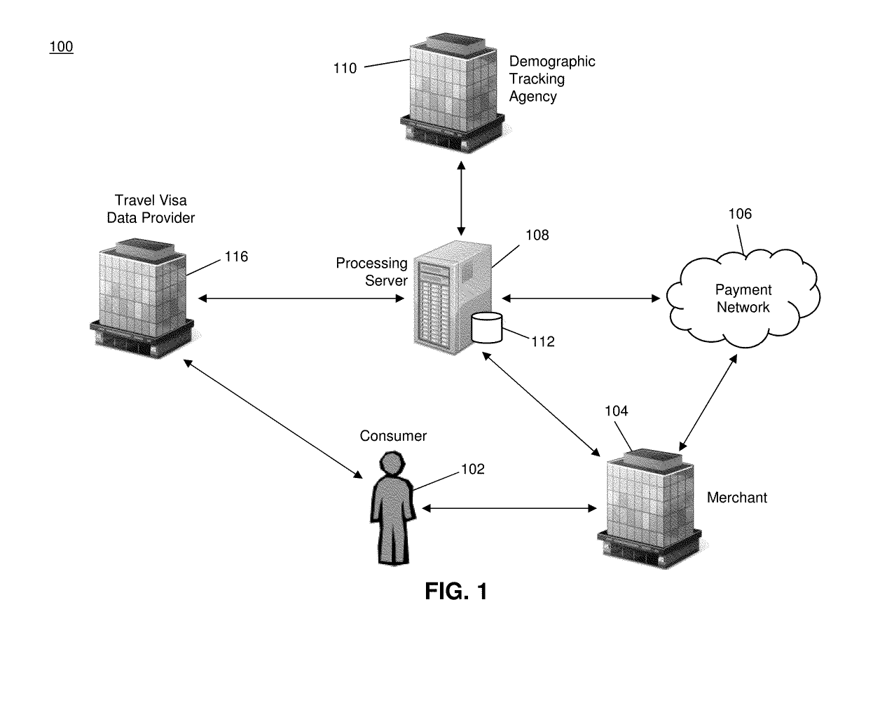

FIG. 1 illustrates a system 100 for linking travel visa data to consumer transaction history.

A consumer 102 may engage in one or more payment transactions at a merchant 104. The payment transaction or transactions may be conducted in person (e.g., at a physical location of the merchant 104), or remotely, such as via the Internet, telephone, by e-mail or regular mail, text messaging, etc. The transaction may be processed via a payment network 106. The payment network 106 may transmit a copy of the authorization request or transaction data included therein to a processing server 108, discussed in more detail below. The processing server 108 may store the transaction data in a consumer profile of a consumer database 112, also discussed in more detail below, associated with the consumer 102. In an exemplary embodiment, the transaction data may only be stored in a consumer profile associated with the particular consumer 102 with the permission of the consumer 102.

The processing server 108 may receive demographic characteristics associated with the consumer 102 from a demographic tracking agency 110 or other third party. The demographic characteristics may include: age, gender, income, marital status, familial status, residential status, occupation, education, zip code, postal code, street address, county, city, state, country, etc. The processing server 108 may store the demographic characteristics in the consumer profile associated with the consumer 102. In an exemplary embodiment, the consumer profile associated with the consumer 102 may not include any personally identifiable information. In some instances, the consumer 102 may be grouped with a plurality of consumers having similar or the same demographic characteristics.

The system 100 may include a travel visa data provider 116. The travel visa data provider 116 may be configured to store travel visa data associated with one or more consumers 102. The travel visa data provider 116 may be, for example, the issuing agency for travel visas for a country, a processing service that manages travel visas, an immigration agency, or other suitable data entity configured to obtain and provide data regarding issued travel visas.

The travel visa data provider 116 may be configured to furnish stored travel visa data to the processing server 108, which may then store the data in corresponding consumer profiles in the consumer database 112. In some embodiments, the travel visa data provider 116 may provide travel visa data to the processing server 108 associated with demographic characteristics corresponding to the consumer 102 associated with respective travel visa data. In such an embodiment, the processing server 108 may match the travel visa data to one or more consumer profiles based on the demographic characteristics and the consumer characteristics of the one or more consumer profiles.

In other embodiments, the processing server 108 may transmit demographic characteristics for one or more consumer profiles to the travel visa data provider 116. The travel visa data provider 116 may then identify travel visa data corresponding to the consumer characteristics, and distribute the identified travel visa data to the processing server 108. The processing server 108 may then store the travel visa data in the corresponding one or more consumer profiles. Methods for identifying correspondence between demographic characteristics and consumer characteristics are discussed in more detail below. Additional methods for obtaining the travel visa data for one or more consumers without personally identifying a consumer will be apparent to persons having skill in the relevant art.

The processing server 108 may then have transaction history and travel visa data for a consumer 102 linked together in a consumer profile associated with the consumer 102. In an exemplary embodiment, the consumer profile may not include any personally identifiable information for the consumer 102, except with the express consent of the consumer 102. By linking transaction history with travel visa data, the processing server 108, or a third party, such as an advertiser, that may receive the data from the processing server 108, may be able to obtain significantly more data from a consumer's combined travel visa and transaction history than utilizing either set of data alone. For instance, a consumer that is interested in professional sports as identified by their transaction history may be identified as a target for advertising regarding sporting events in a country that the consumer is known to be traveling to as indicated by an issued travel visa.

As discussed in more detail below, travel visa data may be grouped among a plurality of consumers 102 to avoid the use of personally identifiable information. In such an instance, a plurality of consumers 102 having similar consumer characteristics may be grouped together into a single profile. As another example, a profile may include consumers 102 that are male, between the ages of 32 and 35, having an income between $50,000 and $75,000, and living in a specific zip code or other designated geographic area. In such an example, the profile may correspond to a number of consumers, such that the travel visa data included in the profile may correspond to each of the consumers and thus not be personally identifiable to any specific consumer. Additional methods and systems for associating consumers based on consumer characteristics and the grouping of consumers for privacy of the consumers can be found in U.S. patent application Ser. No. 13/437,987, entitled “Protecting Privacy in Audience Creation,” to Curtis Villars et al., filed Apr. 3, 2012, which is herein incorporated by reference in its entirety.

In some embodiments, travel visa data may be aggregated by the processing server 108 for a plurality of consumers. For instance, the processing server 108 may receive travel visa data from the travel visa data provider 116 that is associated with all travel visas issued for a specific country and/or during a specific period of time. In such an instance, the processing server 108 may identify consumer profiles stored in the consumer database 112 associated with the travel visas, such as based on purchasing history (e.g., transactions in the issuing country during the applicable period of the visa) and may be able to provide information regarding the overall purchase behavior of the consumers 102 to which the travel visas correspond. For example, the travel visa data may indicate overall trends regarding when consumers travel, where they travel from, and where they travel to, but by associating the travel visa data with transaction data, the processing server 108 may be able to identify what industries the consumer spend on, what lodgings consumers prefer, travel methods used by the consumers, and other such information that may be valuable to many entities, including the issuing country.

### Processing Device

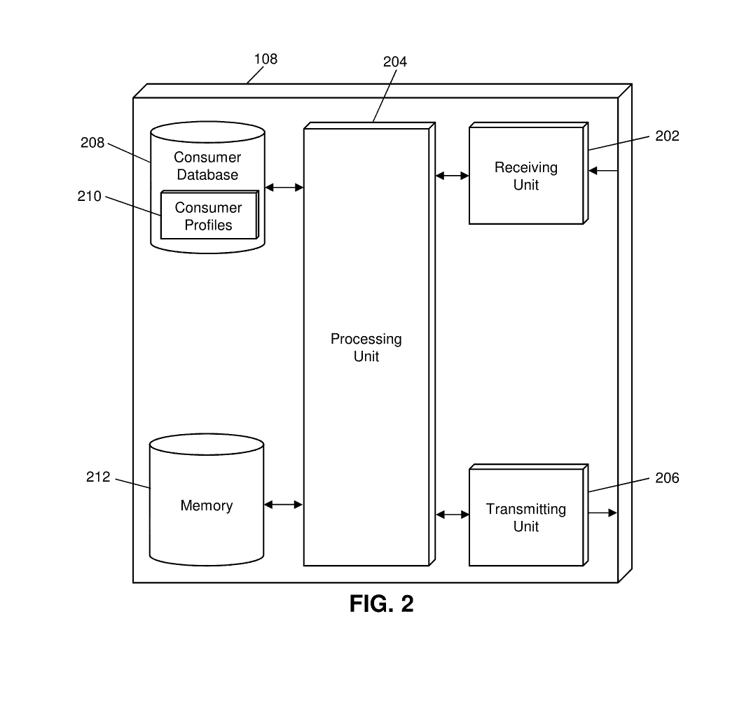

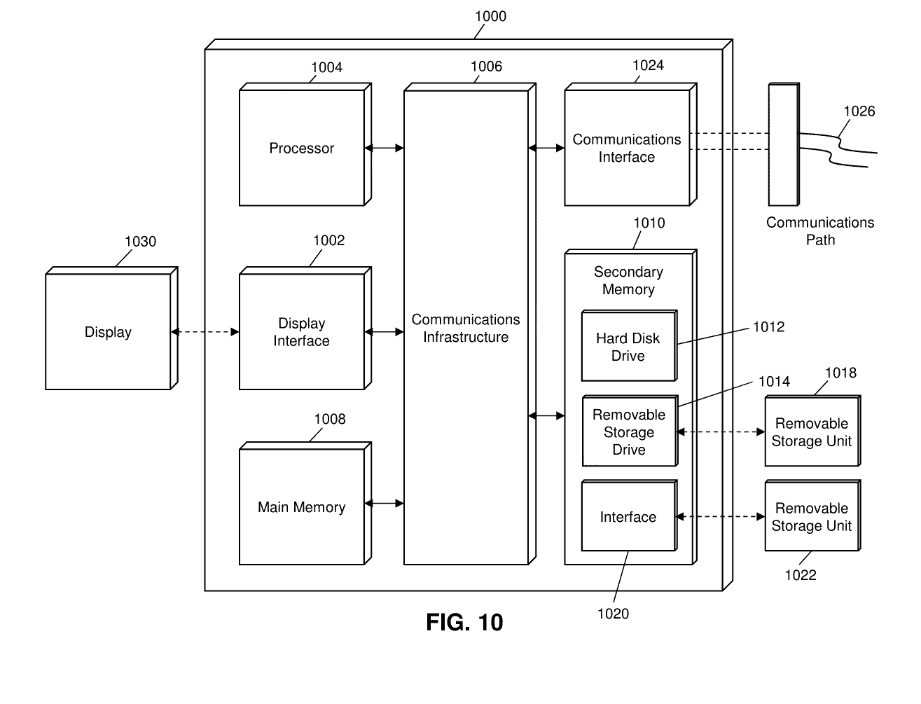

FIG. 2 illustrates an embodiment of the processing server 108 of the system 100. It will be apparent to persons having skill in the relevant art that the embodiment of the processing server 108 illustrated in FIG. 2 is provided as illustration only and may not be exhaustive to all possible configurations of the processing server 108 suitable for performing the functions as discussed herein. For example, the computer system 1000 illustrated in FIG. 10 and discussed in more detail below may be a suitable configuration of the processing server 108.

The processing server 108 may include a receiving unit 202. The receiving unit 202 may be configured to receive data over one or more networks via one or more network protocols. The receiving unit 202 may be configured to receive transaction data, demographic characteristic data, and travel visa data.

The processing server 108 may also include a processing unit 204. The processing unit 204 may be configured to store received transaction data in a transaction database 210 as one or more transaction data entries 212. Each transaction data entry 212 may include data related to a corresponding payment transaction, such as a consumer identifier, merchant identifier, transaction amount, transaction time and/or date, geographic location, merchant name, product data, coupon or offer data, a point-of-sale identifier, or other suitable information as will be apparent to persons having skill in the relevant art. In some embodiment, each transaction data entry may also include demographic characteristics for a consumer (e.g., consumer characteristics) involved in the corresponding payment transaction.

The processing unit 204 may also be configured to store a plurality of consumer profiles 208 in the consumer database 112. Each consumer profile 208 may include data related to one or more consumers (e.g., consumers 102), including at least a plurality of consumer characteristics. In some embodiments, each consumer profile 208 may also include a plurality of transaction data entries 212. In an exemplary embodiment, each consumer profile 208 might not be permitted to include personally identifiable information unless expressly consented to by the corresponding consumer 102. In some embodiments, each consumer profile 208 may be associated with a specific set of consumer characteristics and may accordingly be related to a generic consumer of those characteristics rather than an actual consumer 102. In other embodiments, each consumer profile 208 may be associated with a microsegment of consumers 102.

The processing unit 204 may be configured to link consumer profiles 208 with transaction data entries 212 based on demographic characteristics. The processing unit 204 may also be configured to link consumer profiles 208 including transaction data entries 212 with travel visa data received by the receiving unit 202. The processing unit 204 may be configured to link the consumer profiles 208 with the travel visa data via demographic characteristics included in the consumer profiles 208 and in the received travel visa data. In some instances, the processing unit 204 may match travel visa data to transaction history based on a predefined number of demographic characteristics (e.g., at least the predefined number of characteristics must match). In other instances, transaction history and travel visa data may be matched via algorithms or other systems and methods that will be apparent to persons having skill in the relevant art. In some embodiments, the processing unit 204 may store the received travel visa data in the linked consumer profile 208.

The processing server 108 may also include a transmitting unit 206. The transmitting unit 206 may be configured to transmit data over one or more networks via one or more network protocols. The transmitting unit 206 may be configured to transmit requests for data, such as to the demographic tracking agency 110 and/or the travel visa data provider 116. The transmitting unit 206 may also be configured to transmit transaction history and/or travel visa data, or a consumer profile 208 including linked transaction history and travel visa data, in response to a request from a third party (e.g., an advertiser).

The processing unit 204 may be further configured to identify consumer profiles 210 that correspond to travel visas for which travel visa data is received by the receiving unit 202. Corresponding consumer profiles 210 may be identified by the processing unit 204 based on data included in the respective travel visa, such as the issuing country and one or more travel dates, and the transaction data included in the consumer profile 210, such as a geographic location and transaction time and/or date. The processing unit 204 may also be configured to analyze the identified consumer profiles 210, such as to perform analysis of consumer data or transaction data included therein. In some embodiments, the transmitting unit 206 may be configured to transmit the consumer data or transaction data, such as in response to a request received by the receiving unit 202.

### Method for Linking Travel Visa Data to Transaction History

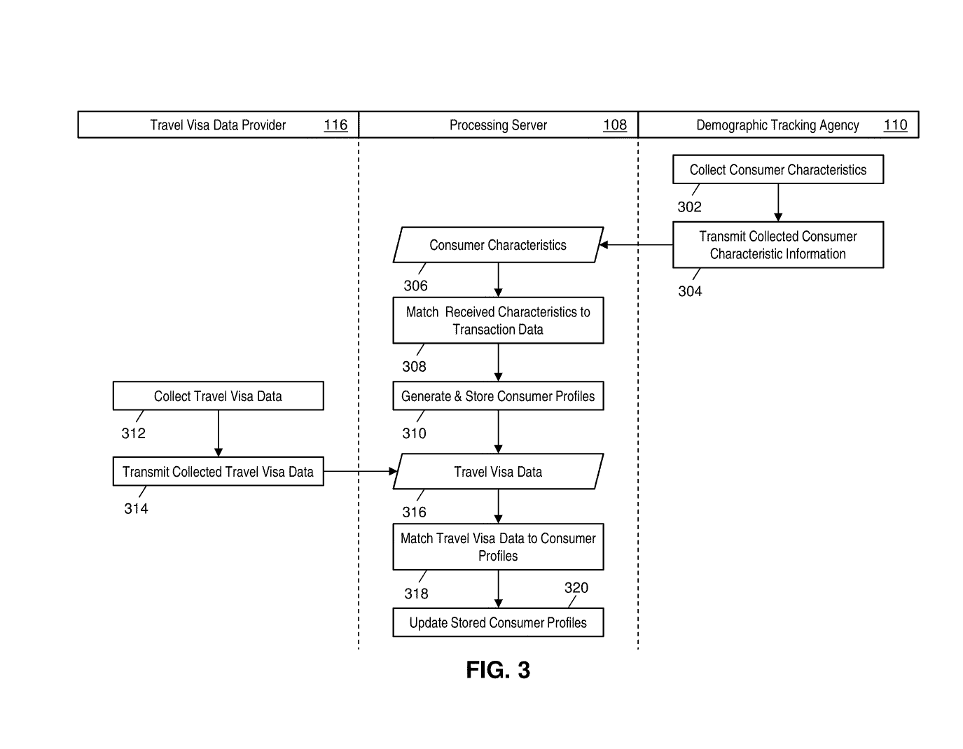

FIG. 3 illustrates a method for linking consumer travel visa data to transaction history.

In step 302, the demographic tracking agency 110 may collect demographic characteristics for one or more consumers. Methods and systems for collecting demographic characteristics will be apparent to persons having skill in the relevant art. The demographic tracking agency 110 may collect the information and may, in step 304, transmit the collected demographic characteristic information to the processing server 108.

In step 306, the processing server 108 may receive the demographic characteristic information. In step 308, the processing unit 204 of the processing server 108 may match the received demographic characteristic information to transaction data entries 212 included in the transaction database 210. In step 310, the processing unit 204 may generate consumer profiles 208 for matched transaction history and demographic characteristics (e.g., consumer characteristics) and store the consumer profiles 208 in the consumer database 112. In an exemplary embodiment, the processing unit 204 may bucket or otherwise modify the consumer characteristic information and/or transaction data to render the corresponding consumer profile 208 not personally identifiable. In some instances, the processing unit 204 may group transaction data entries 212 for multiple consumers sharing consumer characteristics into a single consumer profile 208.

In step 312, the travel visa data provider 116 may store travel visa profiles for one or more consumers 102, the travel visa profiles including travel visa data and a plurality of demographic characteristics that are associated with the corresponding one or more consumers 102. In step 314, the travel visa data provider 116 may transmit the collected travel visa profile to the processing server 108. The processing server 108 may, in step 316, receive the travel visa profile from the travel visa data provider 116.

In step 318, the processing unit 204 of the processing server 108 may match the received travel visa data to the consumer profiles 208 based on matching of the demographic and consumer characteristics. In step 320, the processing unit 320 may update the consumer profiles 208 to include and/or be associated with the matched travel visa data.

### Method for Distributing a Consumer Profile

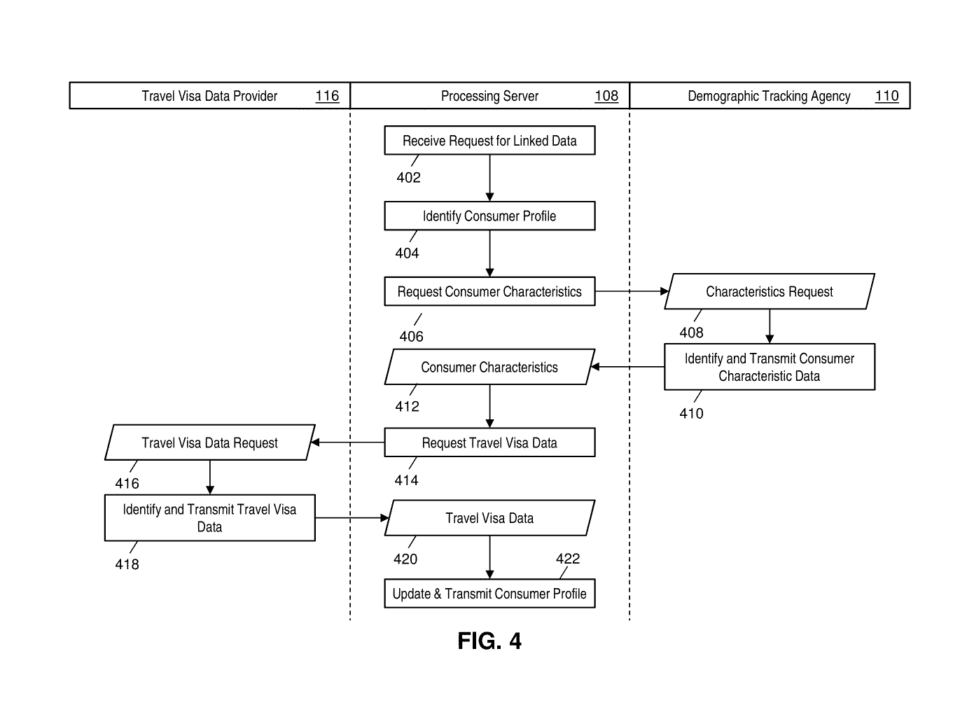

FIG. 4 illustrates a method for distributing a consumer profile including linked travel visa data and transaction history.

In step 402, the processing server 108 may receive (e.g., via the receiving unit 202) a request for linked consumer travel visa and transaction data. The request for linked data may include a consumer identifier or other identifying information, such as consumer characteristics. In step 404, the processing unit 204 may identify, in the consumer database 112, a consumer profile 208 based on the information included in the request.

In step 406, the processing server 108 may transmit (e.g., via the transmitting unit 206), a request for consumer characteristics for the consumer associated with the identified consumer profile 208. In step 408, the demographic tracking agency 110 may receive the request, and, in step 410, may identify consumer characteristics associated with the consumer and transmit them back to the processing server 108. In step 412, the processing server 108 may receive the consumer characteristics associated with the consumer 102 related to the identified consumer profile 208.

In step 414, the processing server 108 may request travel visa data for the consumer 102 from the travel visa data provider 116. The travel visa data request may include the previously received consumer characteristics. In step 416, the travel visa data provider 116 may receive the travel visa data request, and, in step 418, identify travel visa data associated with the consumer characteristics received in the travel visa data request. The travel visa data provider 116 may transmit the travel visa data to the processing server 108, which may receive the travel visa data in step 420.

In step 422, the processing server 108 may update the consumer profile 208 to include the received travel visa data, and may transmit the consumer profile 208 and/or the included transaction history and travel visa data as a response to the initially received request. In an exemplary embodiment, the consumer profile 208 may not include any personally identifiable information for the related consumer 102. In other embodiments, the processing server 108 may remove and/or render personally unidentifiable any personally identifiable information included in the consumer profile 208.

### Method for Linking Consumer Profiles to Travel Visa Data

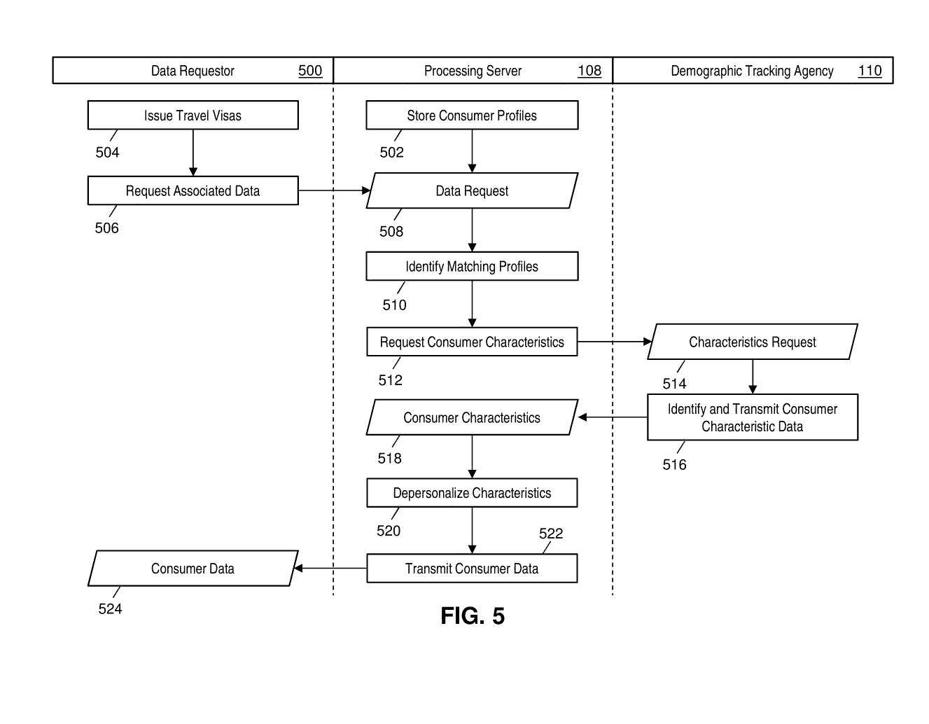

FIG. 5 illustrates a method for linking consumer profiles to travel visa data using transaction history.

In step 502, the processing unit 204 of the processing server 108 may store the consumer profiles 210 in the consumer database 208. Each consumer profile 210 may include data related to one or more consumers 102 including consumer data and a plurality of transaction data entries associated with payment transactions involving the related one or more consumers 102. Each transaction data entry may include a geographic location and a transaction time and/or date. In step 504, a data requestor 500, such as an visa issuing agency, may issue travel visas to a plurality of consumers 102.

In step 506, the data requestor 500 may submit a request for data associated with the issued travel visas to the processing server 108. In step 508, the receiving unit 202 of the processing server 108 may receive the data request, which may include travel visa data for the plurality of issued travel visas including at least an issuing country and one or more travel dates associated with each issued travel visa. In step 510, the processing unit 204 may identify a consumer profile 210 for each issued travel visa that matches the travel visa based on a correspondence between the issuing country and travel dates of the travel visa and the geographic location and transaction time and/or date of the transactions in the matched consumer profile 210.

In step 512, the transmitting unit 206 of the processing server 108 may transmit a request for consumer characteristics to the demographic tracking agency 110. The request for consumer characteristics may be received by the demographic tracking agency 110, in step 514. The request for consumer characteristics may include data suitable for identification of consumer characteristics for the identified plurality of consumer profiles 210. In some embodiments, the data may not include any personally identifiable data. For example, the request may include aggregated consumer data.

In step 516, the demographic tracking agency 110 may identify consumer characteristic data and may transmit the consumer characteristic data to the processing server 108 in response to the request. In step 518, the receiving unit 202 may receive the consumer characteristics. In step 520, the processing unit 204 may depersonalize the consumer characteristics. Depersonalization of consumer characteristics may include the removal of any potentially personally identifiable information through one or more suitable methods that will be apparent to persons having skill in the relevant art, such as bucketing.

In step 522, the transmitting unit 206 may transmit consumer data for the identified consumer profiles 210 to the data requestor 500. In step 524, the data requestor 500 may receive the consumer data. The consumer data may include the consumer characteristics, and may also include transaction data included in the transaction data entries included in each identified consumer profile 210. The data requestor 500 may then use the data for any suitable purpose, such as for the tourism development, advertising, etc.

### Linking Travel Visa Data to Transaction History

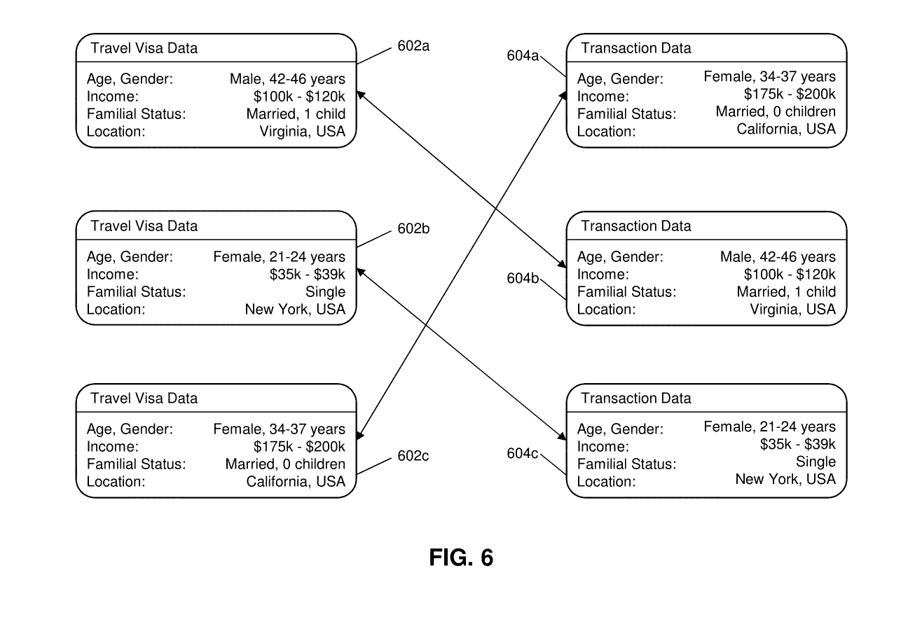

FIG. 6 illustrates the linking of consumer travel visa data 602 to transaction history 604 using demographic characteristics.

Each set of travel visa data 602, illustrated in FIG. 6 as travel visa data 602a, 602b, and 602c, may correspond to a consumer 102 and include a plurality of demographic characteristics. For example, travel visa data 602a corresponds to a consumer 102 that is a male, of an age between 42 and 46 years old, has an income between $100,000 and $120,000, is married, has one child, and lives in Virginia. In some embodiments, the travel visa data 602a may correspond to a plurality of consumers each having the same demographic characteristics data.

Each set of transaction data 604, illustrated in FIG. 6 as transaction data 604a, 604b, and 604c, may correspond to a consumer 102 or a plurality of consumers 102, and include a plurality of consumer characteristics associated with the corresponding consumer or consumers 102. For example, transaction data 604a may correspond to a consumer 102 that is a female, of an age between 34 and 37 years old, has an income between $175,000 and $200,000, is married, has no children, and lives in California.

The processing unit 204 of the processing server 108 may identify the demographic characteristics for each of the travel visa data 602 and transaction data 604 and match the two sets of data based on common demographic and consumer characteristics. For example, in the example illustrated in FIG. 6, the processing unit 204 may match travel visa data 602a with transaction data 604b, travel visa data 602b with transaction data 604c, and travel visa data 602c with transaction data 604a. The processing unit 204 may then store the linked data in one or more consumer profiles 208 including the corresponding consumer characteristics.

In some embodiments, the demographic characteristics for the travel visa data 602 may not directly correspond to the consumer characteristics for the transaction data 604. In such an instance, the processing unit 204 may be configured to link the data based on a predefined number of matching characteristics. For example, if the transaction data 604b was associated with a consumer 102 having two children (instead of one child as illustrated in FIG. 6), while the travel visa data 602a is associated with a consumer 102 having only one child, the processing unit 204 may still link the two sets of data because the sets have at least five matching demographic characteristics including age, gender, income, marital status, and geographic location.

### Exemplary Method for Linking Travel Visa Data to Transaction History

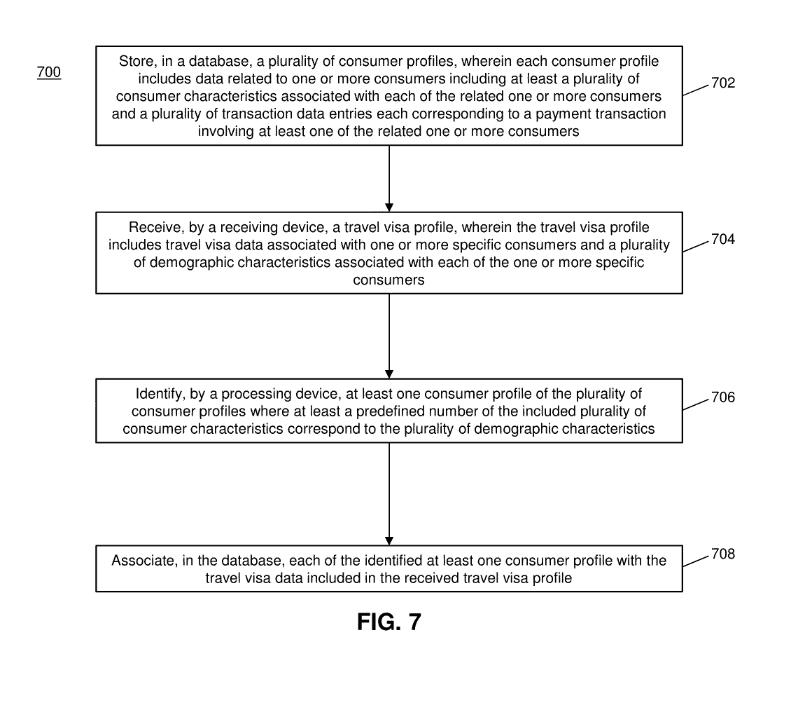

FIG. 7 illustrates a method 700 for linking consumer travel visa data to transaction history using demographic characteristics.

In step 702, a plurality of consumer profiles (e.g., the consumer profiles 208) may be stored in a database (e.g., the consumer database 112), wherein each consumer profile 208 includes data related to one or more consumers (e.g., the consumer 102) including at least a plurality of consumer characteristics associated with each of the related one or more consumers 102 and a plurality of transaction data entries (e.g., transaction data entries 212) each corresponding to a payment transaction involving at least one of the related one or more consumers 102. In some embodiments, the plurality of consumer characteristics may not be personally identifiable.

In one embodiment, the plurality of consumer characteristics may include at least one of: age, gender, income, marital status, familial status, residential status, occupation, education, zip code, postal code, street address, county, city, state, and country. In some embodiments, each transaction data entry 212 may include at least transaction data, a consumer identifier associated with the related consumer 102, and a merchant identifier associated with a merchant (e.g., the merchant 104) involved in the corresponding payment transaction. In a further embodiment, the transaction data may include at least one of: a transaction amount, product data, transaction time and/or date, geographic location, coupon data, and point-of-sale identifier.

In step 704, a travel visa profile may be received, by a receiving device (e.g., the receiving unit 202), wherein the travel visa profile includes travel visa data associated with one or more specific consumers 102 and a plurality of demographic characteristics associated with each of the one or more specific consumers. In one embodiment, the one or more consumers may be a community of consumers. In some embodiments, the plurality of demographic characteristics may not be personally identifiable.

In step 706, at least one consumer profile 208 of the plurality of consumer profiles may be identified, by a processing device (e.g., the processing unit 204), where at least a predefined number of the included plurality of consumer characteristics correspond to the plurality of demographic characteristics. In step 708, each of the identified at least one consumer profiles 208 may be associated, in the database 112, with the travel visa data included in the received travel visa profile.

### Exemplary Method for Distributing a Linked Consumer Profile

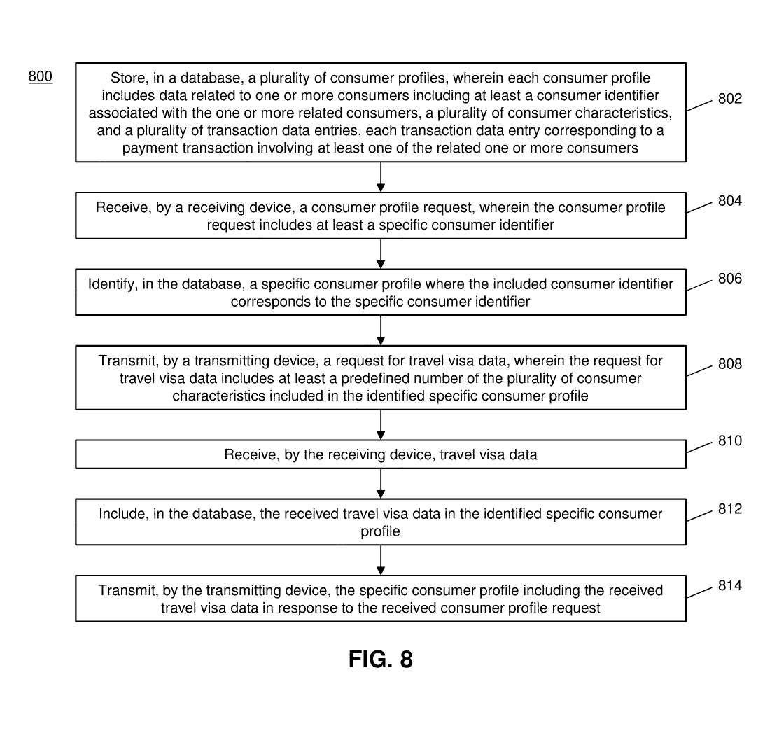

FIG. 8 illustrates a method 800 for distributing a consumer profile including travel visa data and transaction history linked based on demographic characteristics.

In step 802, a plurality of consumer profiles (e.g., the consumer profiles 208) may be stored, in a database (e.g., the consumer database 112), wherein each consumer profile 208 includes data related to one or more consumers (e.g., consumers 102), including at least a consumer identifier associated with the one or more related consumers 102, a plurality of consumer characteristics, and a plurality of transaction data entries (e.g., transaction data entries 212), each transaction data entry corresponding to a payment transaction involving at least one of the related one or more consumers 102. In some embodiments, the plurality of demographic characteristics may not be personally identifiable.

In one embodiment, the plurality of consumer demographic characteristics may include at least one of: age, gender, income, marital status, familial status, residential status, occupation, education, zip code, postal code, street address, county, city, state, and country. In some embodiments, each transaction data entry 212 may include at least transaction data, a consumer identifier associated with the related consumer 102, and a merchant identifier associated with a merchant (e.g., the merchant 104) involved in the corresponding payment transaction. In a further embodiment, the transaction data may include at least one of: a transaction amount, product data, transaction time and/or date, geographic location, coupon data, and point-of-sale identifier.

In step 804, a consumer profile request may be received, by a receiving device (e.g., the receiving unit 202), wherein the consumer profile request includes at least a specific consumer identifier. In step 806, a specific consumer profile 208 may be identified, in the database 112, where the included consumer identifier corresponds to the specific consumer identifier. In step 808, a request for travel visa data may be transmitted, by a transmitting device (e.g., the transmitting unit 206), wherein the request for travel visa data includes at least the plurality of consumer characteristics included in the identified specific consumer profile 208.

In step 810, the receiving device 202 may receive travel visa data. In one embodiment, the request for travel visa data may further include a predefined number, the received travel visa data may be associated with demographic characteristics, and a number of the plurality of consumer characteristics included in the specific consumer profile 208 that correspond to the plurality of demographic characteristics is at least the predefined number. In a further embodiment, the plurality of demographic characteristics may not be personally identifiable.

In step 812, the received travel visa data may be included in the identified specific consumer profile 208 of the database 112. In step 814 the transmitting device 206 may transmit the specific consumer profile 208, including the received travel visa data, may be transmitted in response to the received consumer profile request.

### Exemplary Method for Linking Travel Visa Data to Consumer Data

In step 902, a plurality of consumer profiles (e.g., consumer profiles 210) may be stored in a database (e.g., the consumer database 208), wherein each consumer profile 210 includes data related to one or more consumers (e.g., consumers 102) including at least a consumer identifier associated with the one or more related consumers 102, consumer data, and a plurality of transaction data entries, each transaction data entry corresponding to a payment transaction involving at least one of the related one or more consumers 102 and including at least a geographic location and a transaction time and/or date. In one embodiment, the consumer data may not include any personally identifiable information. In some embodiments, the one or more consumers 102 related to each consumer profile 210 may be a microsegment of consumers 102.

In one embodiment, the consumer data may include a plurality of consumer characteristics including at least one of: age, gender, income, marital status, familial status, residential status, occupation, education, zip code, postal code, street address, county, city, stage, and country. In some embodiments, each transaction data entry may further include transaction data associated with the corresponding payment transaction including at least one of: merchant name, merchant industry, merchant category, payment type, transaction amount, product data, and location data.

In step 904, a receiving device (e.g., the receiving unit 202) may receive travel visa data, wherein the travel visa data includes data related to a plurality of issued travel visas including at least an issuing country and one or more travel dates for each issued travel visa. In step 906, a corresponding consumer profile 210 may be identified in the database 208 for each issued travel visa based on at least the geographic location and transaction time and/or date for one or more transaction data entries in the corresponding consumer profile 210 and the issuing country and one or more travel dates in the respective issued travel visa.

In step 908, at least one of the consumer data and the transaction data entries included in the corresponding consumer profile 210 identified for each issued travel visa included in the received travel visa data may be transmitted by a transmitting device (e.g., the transmitting unit 206). In embodiments where each consumer profile 210 may include consumer characteristics, the transmitting may include transmitting aggregated data of the plurality of consumer characteristics included in the corresponding consumer profile 210 identified for each issued travel visa included in the received travel visa data.

### Computer System Architecture

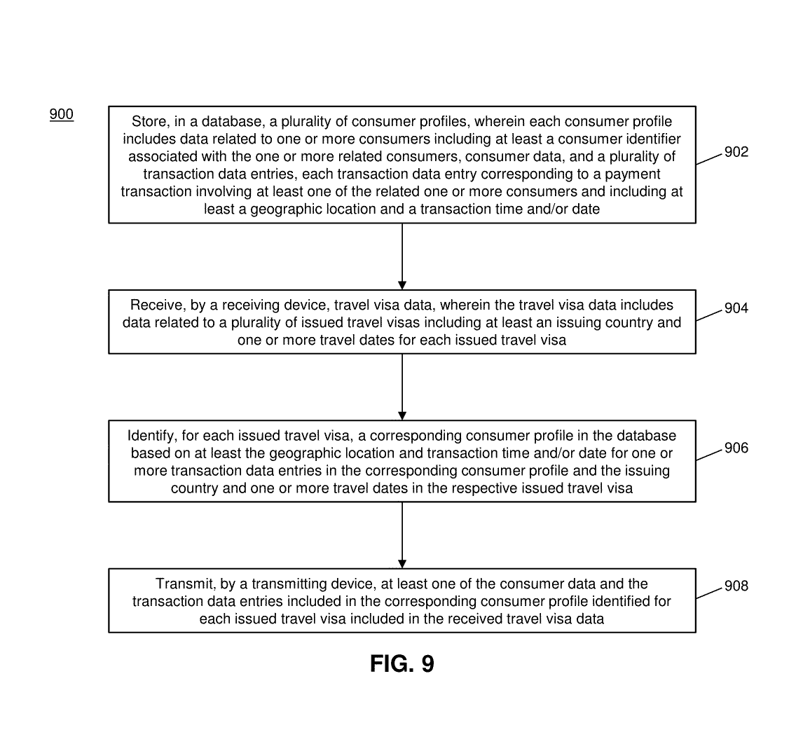

FIG. 10 illustrates a computer system 1000 in which embodiments of the present disclosure, or portions thereof, may be implemented as computer-readable code. For example, the processing server 108 of FIG. 1 may be implemented in the computer system 1000 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3-5 and 7-9.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 1018, a removable storage unit 1022, and a hard disk installed in hard disk drive 1012.

Various embodiments of the present disclosure are described in terms of this example computer system 1000. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 1004 may be a special purpose or a general purpose processor device. The processor device 1004 may be connected to a communications infrastructure 1006, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 1000 may also include a main memory 1008 (e.g., random access memory, read-only memory, etc.), and may also include a secondary memory 1010. The secondary memory 1010 may include the hard disk drive 1012 and a removable storage drive 1014, such as a floppy disk drive, a magnetic tape drive, an optical disk drive, a flash memory, etc.

The removable storage drive 1014 may read from and/or write to the removable storage unit 1018 in a well-known manner. The removable storage unit 1018 may include a removable storage media that may be read by and written to by the removable storage drive 1014. For example, if the removable storage drive 1014 is a floppy disk drive or universal serial bus port, the removable storage unit 1018 may be a floppy disk or portable flash drive, respectively. In one embodiment, the removable storage unit 1018 may be non-transitory computer readable recording media.

In some embodiments, the secondary memory 1010 may include alternative means for allowing computer programs or other instructions to be loaded into the computer system 1000, for example, the removable storage unit 1022 and an interface 1020. Examples of such means may include a program cartridge and cartridge interface (e.g., as found in video game systems), a removable memory chip (e.g., EEPROM, PROM, etc.) and associated socket, and other removable storage units 1022 and interfaces 1020 as will be apparent to persons having skill in the relevant art.

Data stored in the computer system 1000 (e.g., in the main memory 1008 and/or the secondary memory 1010) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 1000 may also include a communications interface 1024. The communications interface 1024 may be configured to allow software and data to be transferred between the computer system 1000 and external devices. Exemplary communications interfaces 1024 may include a modem, a network interface (e.g., an Ethernet card), a communications port, a PCMCIA slot and card, etc. Software and data transferred via the communications interface 1024 may be in the form of signals, which may be electronic, electromagnetic, optical, or other signals as will be apparent to persons having skill in the relevant art. The signals may travel via a communications path 1026, which may be configured to carry the signals and may be implemented using wire, cable, fiber optics, a phone line, a cellular phone link, a radio frequency link, etc.

The computer system 1000 may further include a display interface 1002. The display interface 1002 may be configured to allow data to be transferred between the computer system 1000 and external display 1030. Exemplary display interfaces 1002 may include high-definition multimedia interface (HDMI), digital visual interface (DVI), video graphics array (VGA), etc. The display 1030 may be any suitable type of display for displaying data transmitted via the display interface 1002 of the computer system 1000, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 1008 and secondary memory 1010, which may be memory semiconductors (e.g., DRAMs, etc.). These computer program products may be means for providing software to the computer system 1000. Computer programs (e.g., computer control logic) may be stored in the main memory 1008 and/or the secondary memory 1010. Computer programs may also be received via the communications interface 1024. Such computer programs, when executed, may enable computer system 1000 to implement the present methods as discussed herein. In particular, the computer programs, when executed, may enable processor device 1004 to implement the methods illustrated by FIGS. 3-5 and 7-9, as discussed herein. Accordingly, such computer programs may represent controllers of the computer system 1000. Where the present disclosure is implemented using software, the software may be stored in a computer program product and loaded into the computer system 1000 using the removable storage drive 1014, interface 1020, and hard disk drive 1012, or communications interface 1024.

Techniques consistent with the present disclosure provide, among other features, systems and methods for linking travel visa data to transaction history and distributing linked consumer profiles. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for linking travel visa data to transaction history data, comprising:
storing, in a database, a plurality of consumer profiles, wherein each consumer profile includes data related to one or more consumers including at least a plurality of consumer characteristics associated with each of the related one or more consumers and a plurality of transaction data entries each corresponding to a payment transaction involving at least one of the related one or more consumers;
receiving, by a receiving device, a travel visa profile, wherein the travel visa profile includes travel visa data associated with one or more specific consumers and a plurality of demographic characteristics associated with each of the one or more specific consumers;
identifying, by a processing device, at least one consumer profile of the plurality of consumer profiles where at least a predefined number of the included plurality of consumer characteristics correspond to the plurality of demographic characteristics; and
associating, in the database, each of the identified at least one consumer profile with the travel visa data included in the received travel visa profile.

2. The method of claim 1, wherein the plurality of consumer characteristics includes at least one of: age, gender, income, marital status, familial status, residential status, occupation, education, zip code, postal code, street address, county, city, state, and country.

3. The method of claim 1, wherein the plurality of consumer characteristics and demographic characteristics are not personally identifiable.

4. The method of claim 1, wherein each consumer profile further includes a consumer identifier associated with the one or more related consumers.

5. The method of claim 4, further comprising:
receiving, by the receiving device, a consumer profile request, wherein the consumer profile request includes at least a specific consumer identifier;
identifying, in the database, a specific consumer profile where the included consumer identifier corresponds to the specific consumer identifier; and
transmitting, by a transmitting device, a request for a travel visa profile, wherein the request for a travel visa profile includes at least the predefined number of the included plurality of consumer characteristics.

6. The method of claim 5, wherein
the travel visa profile is received in response to the transmitted request for a travel visa profile, and
the identified at least one consumer profile includes the identified specific consumer profile.

7. A method for linking travel visa data to consumer data, comprising:
storing, in a database, a plurality of consumer profiles, wherein each consumer profile includes data related to one or more consumers including at least a consumer identifier associated with the one or more related consumers, consumer data, and a plurality of transaction data entries, each transaction data entry corresponding to a payment transaction involving at least one of the related one or more consumers and including at least a geographic location and a transaction time and/or date;
receiving, by a receiving device, travel visa data, wherein the travel visa data includes data related to a plurality of issued travel visas including at least an issuing country and one or more travel dates for each issued travel visa;
identifying, for each issued travel visa, a corresponding consumer profile in the database based on at least the geographic location and transaction time and/or date for one or more transaction data entries in the corresponding consumer profile and the issuing country and one or more travel dates in the respective issued travel visa; and
transmitting, by a transmitting device, at least one of the consumer data and the transaction data entries included in the corresponding consumer profile identified for each issued travel visa included in the received travel visa data.

8. The method of claim 7, wherein the consumer data includes a plurality of consumer characteristics including at least one of: age, gender, income, marital status, familial status, residential status, occupation, education, zip code, postal code, street address, county, city, state, and country.

9. The method of claim 8, wherein transmitting the consumer data included in the corresponding consumer profile identified for each issued travel visa included in the received travel visa data includes transmitting aggregated data of the plurality of consumer characteristics included in the corresponding consumer profile identified for each issued travel visa included in the received travel visa data.

10. The method of claim 7, wherein each transaction data entry further includes transaction data associated with the corresponding payment transaction including at least one of: merchant name, merchant industry, merchant category, payment type, transaction amount, product data, and location data.

11. The method of claim 7, wherein the consumer data does not include any personally identifiable information.

12. A system for linking travel visa data to transaction history data, comprising:
a database configured to store a plurality of consumer profiles, wherein each consumer profile includes data related to one or more consumers including at least a plurality of consumer characteristics associated with each of the related one or more consumers and a plurality of transaction data entries each corresponding to a payment transaction involving at least one of the related one or more consumers;
a receiving device configured to receive a travel visa profile, wherein the travel visa profile includes travel visa data associated with one or more specific consumers and a plurality of demographic characteristics associated with each of the one or more specific consumers; and
a processing device configured to
identifying at least one consumer profile of the plurality of consumer profiles where at least a predefined number of the included plurality of consumer characteristics correspond to the plurality of demographic characteristics, and
associate, in the database, each of the identified at least one consumer profile with the travel visa data included in the received travel visa profile.

13. The system of claim 12, wherein the plurality of consumer characteristics includes at least one of: age, gender, income, marital status, familial status, residential status, occupation, education, zip code, postal code, street address, county, city, state, and country.

14. The system of claim 12, wherein the plurality of consumer characteristics and demographic characteristics are not personally identifiable.

15. The system of claim 12, wherein each consumer profile further includes a consumer identifier associated with the one or more related consumers.

16. The system of claim 15, further comprising:
a transmitting device, wherein
the receiving device is further configured to receive a consumer profile request, wherein the consumer profile request includes at least a specific consumer identifier,
the processing device is further configured to identify, in the database, a specific consumer profile where the included consumer identifier corresponds to the specific consumer identifier, and
the transmitting device is configured to transmit a request for a travel visa profile, wherein the request for a travel visa profile includes at least the predefined number of the included plurality of consumer characteristics.

17. The system of claim 16, wherein
the travel visa profile is received in response to the transmitted request for a travel visa profile, and
the identified at least one consumer profile includes the identified specific consumer profile.

18. A system for linking travel visa data to consumer data, comprising:
a database configured to store a plurality of consumer profiles, wherein each consumer profile includes data related to one or more consumers including at least a consumer identifier associated with the one or more related consumers, consumer data, and a plurality of transaction data entries, each transaction data entry corresponding to a payment transaction involving at least one of the related one or more consumers and including at least a geographic location and a transaction time and/or date;
a receiving device configured to receive travel visa data, wherein the travel visa data includes data related to a plurality of issued travel visas including at least an issuing country and one or more travel dates for each issued travel visa;
a processing device configured to identify, for each issued travel visa, a corresponding consumer profile in the database based on at least the geographic location and transaction time and/or date for one or more transaction data entries in the corresponding consumer profile and the issuing country and one or more travel dates in the respective issued travel visa; and
a transmitting device configured to transmit at least one of the consumer data and the transaction data entries included in the corresponding consumer profile identified for each issued travel visa included in the received travel visa data.

19. The system of claim 18, wherein the consumer data includes a plurality of consumer characteristics including at least one of: age, gender, income, marital status, familial status, residential status, occupation, education, zip code, postal code, street address, county, city, state, and country.

20. The system of claim 19, wherein transmitting the consumer data included in the corresponding consumer profile identified for each issued travel visa included in the received travel visa data includes transmitting aggregated data of the plurality of consumer characteristics included in the corresponding consumer profile identified for each issued travel visa included in the received travel visa data.

21. The system of claim 18, wherein the consumer data does not include any personally identifiable information.
